(19) United States
(12) Patent Application Publication
(10) Pub. No.: US 2013/0249488 A1
(43) Pub. Date: Sep. 26, 2013

(54) BATTERY PACK CHARGING SYSTEM AND METHOD OF CONTROLLING THE SAME

(71) Applicant: SAMSUNG SDI CO., LTD., Yongin-si (KR)

(72) Inventors: Ri-A Ju, Yongin-si (KR); Hyun Kim, Yongin-si (KR); Suk-Kyum Kim, Yongin-si (KR); Seong-Joon Park, Yongin-si (KR); Young-Il Kim, Yongin-si (KR)

(73) Assignee: SAMSUNG SDI CO., LTD., Yongin-si (KR)

(21) Appl. No.: 13/772,170

(22) Filed: Feb. 20, 2013

Related U.S. Application Data
(60) Provisional application No. 61/615,685, filed on Mar. 26, 2012.

(51) Int. Cl. H02J 7/00

(52) U.S. Cl. CPC H02J 7/007
USPC 320/112; 320/137; 320/162; 320/155

(57) ABSTRACT

A battery pack and a method of charging the battery pack are disclosed. The method for charging includes monitoring a state of charge of a battery pack, determining a need for charging the battery pack based on the monitored state of charge of the batter and triggering charging of the battery pack by sending a signal indicative of the need for charging the battery pack based on the determined need for charging the battery pack.

### CROSS-REFERENCE TO RELATED APPLICATIONS

This application claims priority to and the benefit of Provisional Patent Application No. 61/615,685 filed in the U.S. Patent and Trademark Office on Mar. 26, 2012, the entire contents of which are incorporated herein by reference.

### BACKGROUND

1. Field

One or more embodiments of the present invention relate to a battery pack charging system and a method of controlling the same.

2. Description of the Related Technology

In general, unlike primary batteries, which are not rechargeable, secondary batteries are rechargeable and dischargeable. According to the types of external devices to which the secondary batteries are applied, the secondary batteries are used as a single battery or in the form of a battery module in which a plurality of batteries are connected as a unit.

In some systems, a lead storage battery is used as a power supply unit for starting up an engine. Recently, to improve fuel efficiency, an Idle Stop & Go (ISG) system (or start-stop or stop-start) systems have been developed, and the use of these systems is gradually increasing. A power supply unit that supports a start-stop system, which is aimed at limiting the amount of time an engine spends idling, has to maintain strong charging or discharging characteristics despite high output characteristics for engine start up and frequent start ups, and has a long life span. However, charging or discharging characteristics of lead storage batteries may deteriorate due to repeated engine stops or restart-ups under the start-stop system, and cannot be used for a long time.

In an electrical device using electricity, when a system is turned off, power related to basic operations of the electrical device is turned off. However, when the device is turned on again, a current for immediately starting an operation of the electrical device and continuing the basic operations of the electrical device is supplied and is referred to as a dark current.

### SUMMARY OF CERTAIN INVENTIVE ASPECTS

One aspect of the invention is a method of charging a battery pack including determining a need for charging the battery pack, sending a signal to a motor based on a determined need to charge the battery pack, and initiating charging of the battery pack after receipt of the signal.

In some embodiments, determining the need for charging the battery may be based on monitoring a state of charge (SOC) of the battery.

In some embodiments, determining the need for charging the battery may be based on the SOC being below a threshold

In some embodiments, determining the need for charging the battery may be based on passage of a predetermined time period.

In some embodiments, the predetermined time period may be based on discharge characteristics of the battery.

In some embodiments, the motor may be connected to a generator.

In some embodiments, the generator may be operated to charge the battery pack when the signal is sent to the motor.

In some embodiments, the signal may be indicative of the determined need for charging the battery

In some embodiments, determining a need for charging the battery pack may include determining whether the battery pack is connected to an engine that is turned off; and the signal may be sent to the motor if the battery pack is connected to an engine that is turned off.

Another aspect of the invention is a method of charging a battery pack including monitoring a state of charge of a battery pack, determining a need for charging the battery pack based on the monitored state of charge of the batter and triggering charging of the battery pack by sending a signal indicative of the need for charging the battery pack based on the determined need for charging the battery pack.

In some embodiments, determining the need for charging the battery pack includes determining the need when the monitored state of charge of the battery pack crosses a predetermined threshold value.

In some embodiments, the predetermined threshold value includes a percentage of a level associated with a completely charged battery pack.

In some embodiments, the triggering charging of the battery pack is further based on a predetermined time period.

In some embodiments, the predetermined time period is based on a linear discharge characteristic of the battery pack.

Another aspect of the invention is a battery pack including a controller configured to monitor a state of charge of a battery, a processor configured to determine a need for charging the battery based on the state of charge of the battery, and circuitry configured to trigger charging of the battery based on the determined need for charging the battery, where the circuitry is further configured to send a signal indicative of the need for charging the battery to a starter motor.

In some embodiments, the battery pack may be at least one of a lithium ion battery pack and a nickel metal hydride battery pack.

In some embodiments, the signal sent to the starter motor may be configured to automatically drive the power generator to charge the battery.

Another aspect of the invention is a vehicle including a battery pack including a controller configured to monitor a state of charge of a battery pack, a processor configured to determine a need for charging the battery pack based on the state of charge of the battery pack, and circuitry configured to trigger charging of the battery pack based on the determined need for charging the battery pack, where the circuitry is further configured to send a first signal indicative of the need for charging the battery pack to a starter motor, the starter motor electrically connected to the battery pack, the starter motor configured to receive the first signal indicative of the need for charging the battery pack, and a generator connected to the battery pack, the generator configured to charge the battery pack.

In some embodiments, the circuitry is configured to send the first signal when the monitored state of charge of the battery is below a predetermined threshold value.

In some embodiments, the circuitry is configured to send a second signal to the starter motor when the monitored state of charge of the battery is above a predetermined threshold value.

### BRIEF DESCRIPTION OF THE DRAWINGS

FIG. 1 is a schematic view illustrating a structure of a battery pack according to an embodiment of the present invention and a connection between the battery pack and external peripheral devices;

FIG. 2 is a graph showing a state-of-charge (SOC) of a battery module when an engine of a vehicle is stopped;

FIG. 3 is a graph showing an SOC of a battery module according to an embodiment of the present invention, when the battery module is automatically charged;

FIG. 4 is a graph showing an SOC of a battery module according to another embodiment of the present invention, when the battery module is automatically charged;

FIG. 5 is a flowchart illustrating a method of controlling a battery charging system, according to an embodiment of the present invention; and

FIG. 6 is a flowchart illustrating a method of controlling a battery charging system, according to another embodiment of the present invention.

### DETAILED DESCRIPTION OF CERTAIN INVENTIVE EMBODIMENTS

The present invention will now be described more fully with reference to the accompanying drawings, in which certain embodiments of the invention are shown. The embodiments will be described in detail such that one of ordinary skill in the art may easily work the present invention. It should be understood that the embodiments of the present invention may vary but do not have to be mutually exclusive. For example, particular shapes, structures, and properties according to a predetermined embodiment described in this specification may be modified in other embodiments without departing from the spirit and scope of the prevent invention. In addition, positions or arrangement of individual components of each of the embodiments may also be modified without departing from the spirit and scope of the present invention. Accordingly, the detailed description below should not be construed as having limited meanings but construed to encompass the scope of the claims and any equivalent ranges thereto. In the drawings, like reference numerals generally denote like elements in various aspects.

Hereinafter, the present invention will now be described more fully with reference to the accompanying drawings, in which certain embodiments of the present invention are shown such that one of ordinary skill in the art may easily work the invention.

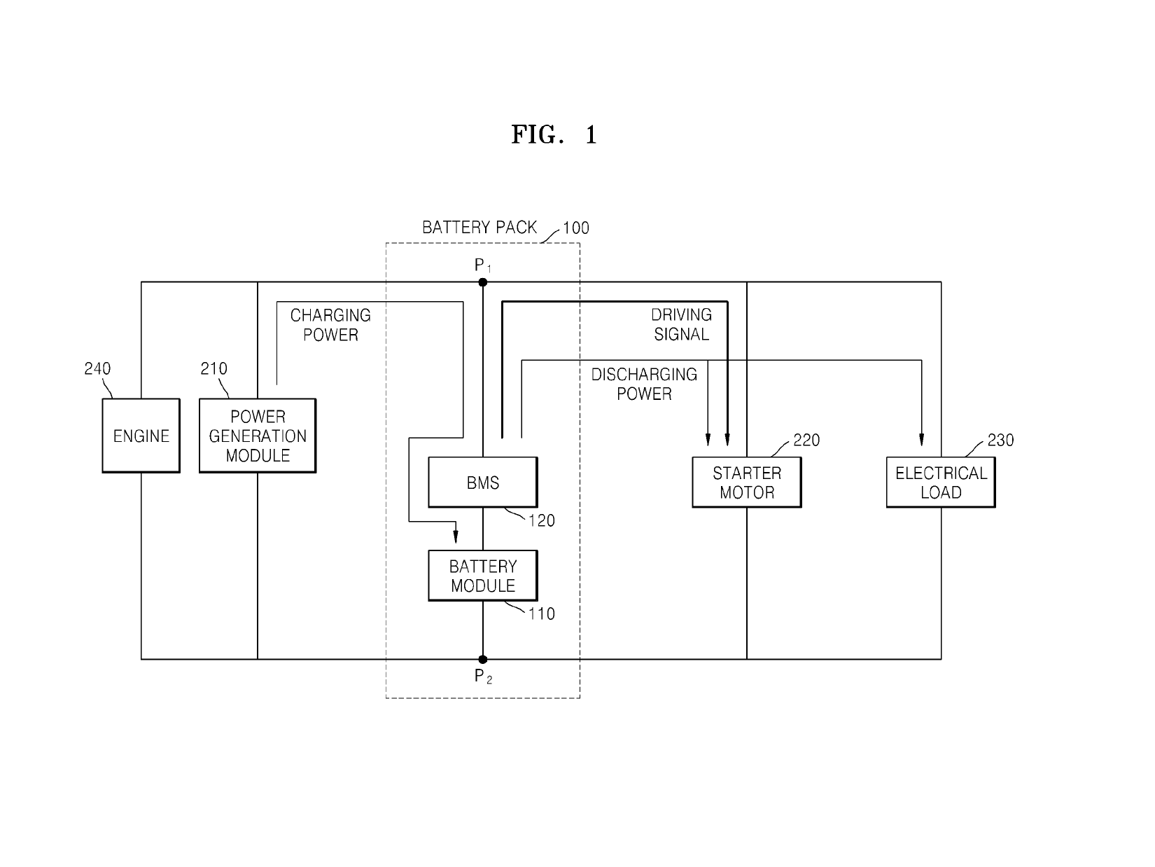

FIG. 1 is a schematic view illustrating a structure of a battery pack 100 according to an embodiment of the present invention and a connection between the battery pack 100 and external peripheral devices.

The battery pack 100 includes a battery module 110 that is connected between first and second terminals P1 and P2 to receive charging power and output discharging power. The battery pack 100 may be electrically connected in parallel to a power generation module 210, an engine 240, and a starter motor 220 via the first and second terminals P1 and P2. Also, as illustrated in FIG. 1, the battery pack 100 includes a battery management system (BMS) 120.

The battery pack 100 may store charging power generated from the power generation module 210 and supply discharging power to the starter motor 220. For example, the power generation module 210 may be connected to engine 240 to provide power thereto, and may be connected to a driving axis of the engine 240 to convert rotational motive power into an electrical output. Charging power generated by the power generation module 210 may be stored in the battery module 110 via the first and second terminals P1 and P2 of the battery pack 100. For example, the power generation module 210 may include a direct current (DC) generator (not shown) or an alternating current (AC) generator (not shown) and a rectifying unit (not shown), and may supply power of about 15 V DC.

For example, the battery pack 100 may be used as a power unit for starting up engine 240. In some embodiments, the engine 240 may operate in a start-stop system, in which the start-stop function is implemented to improve fuel efficiency. In the start-stop system, as the engine 240 is repeatedly and frequently stopped and restarted, charging and discharging of the battery pack 100 are repeated.

A lead storage battery applied to existing start-stop systems may have a decrease in durability and a life span and a decrease in charging and discharging characteristics due to frequent repetition of charging and discharging operations. In such systems, starting up of an engine may be degraded, and an exchange cycle of the lead storage battery is shortened.

In some embodiments, the battery module 110 includes a lithium ion battery which maintains relatively uniform charging or discharging characteristics, and thus, has little deterioration and may be suitable for a start-stop system where stopping and re-startup of an engine 240 is repeated. Compared to a lead storage battery of the same charging capacity, the battery module 110 according to embodiments of the present invention obtains the same charging capacity with less volume than the lead storage battery, and thus, a mounting space of the battery module 110 may be reduced. In some embodiments, a nickel metal hydride (NiMH) battery may be used as the battery module 110.

The battery module 110 may include a plurality of battery cells (not shown) that are connected serially or parallel, and a rated charging voltage and a charging capacity of the battery cells may be adjusted through combinations of serial and parallel connections.

The battery module 110 is a general name of a structure including a plurality of battery sub-units. For example, when the battery pack 100 is a battery rack including a plurality of battery trays, the battery rack may be regarded as the battery module 110. Also, when a battery tray includes a plurality of battery cells, the battery tray may be regarded as the battery module 110.

The BMS 120 monitors a battery state and controls charging and discharging operations thereof. In some embodiments, the BMS 120 may include a controller, a sensor, or the like. In some embodiments, the BMS 120 monitors a state-of-charge (SOC) of the battery module 110 and automatically drives the starter motor 220 to determine whether to receive charging power from the power generation module 210 or not. The function and operation of the BMS 120 is described below.

The power generation module 210 may function like an alternator of a vehicle. An alternator not only supplies charging power to the battery pack 100 but also power to an electrical load 230 while the engine 240 is driven, as described below.

In some embodiments, when an SOC of the battery module 110 is reduced to a predetermined value or lower, the power generation module 210 receives rotational driving power from the engine 240 by automatic driving of the starter motor 220 to supply charging power to the battery pack 100.

Next, the starter motor 220 is driven when the engine 240 of a vehicle is started up, and may provide an initial rotational motive power that rotates a driving axis of the engine 240. For example, the starter motor 220 may receive stored power via the first and second terminals P1 and P2 of the battery pack 100 and rotate a driving axis of the engine 240 when the engine 240 is started up or when the engine 240 is restarted after an idle stop, thereby re-driving the engine 240. When a user starts up a vehicle or at a moment of an idle go, the starter motor 220 provides an initial rotational motive power of the engine 240. In some embodiments, while the engine 240 is operated by the starter motor 220, the power generation module 210 may be driven to generate charging power.

As described above, as the starter motor 220 receives an initial ignition motive power via the first and second terminals P1 and P2 of the battery pack 100, when the battery module 110 is completely discharged, the engine 240 may not be operated or operated again via the starter motor 220. In particular, in the case of a start-stop vehicle, re-operation of the engine 240 is to be performed frequently, and thus, if the battery module 110 is completely discharged, and thus, the starter motor 220 is not to be operated, serious problems may occur, for example, the vehicle may not be able to start in an idle stop state.

According to some embodiments, if an SOC of the battery module 110 is decreased to a discharging limit or below, the starter motor 220 may be automatically operated. The starter motor 220 may be connected to the BMS 120, and when a signal indicating that an SOC of the battery module 110 is decreased to a discharging limit or below is received from the BMS 120, the starter motor 220 automatically operates to work the engine 240, thereby driving the power generation module 210.

As described above, as the BMS 120 monitors an SOC of the battery module 110 so as to automatically operate the starter motor 220, the SOC of the battery module 110 may be always maintained at a discharging limit or higher. That is, the power generation module 210 is driven to supply charging power to the battery module 110, and thus, even when the battery is discharged while operation of the engine 240 is stopped, a charging value of the battery module 110 for starting or restarting the engine 240 may always be maintained.

Together with the power generation module 210 and the starter motor 220, the electrical load 230 may be connected to the battery pack 100. The electrical load 230 consumes power stored in the battery pack 100, may receive stored discharging power via the first and second terminals P1 and P2, and may include various components for electrical devices.

Examples of the electrical load 230 include an air conditioner for vehicles, a radio, a remote reception terminal, or the like, but are not limited thereto; the electrical load 230 may refer to any type of a load that operates upon receiving power from the power generation module 210 or the battery module 110.

The electrical load 230 may generate a dark current while the engine 240 is stopped. In a vehicle, if the engine 240 is stopped, a flow of a current supplied to a starting device and other loading apparatuses is stopped in a battery, but a current for immediately starting up engine 240 is supplied by starter motor 220 or a current of a battery is supplied to the electrical load 230 such as other types of controllers, that is, a dark current, is continuously supplied electrical load 230.

The dark current consumed by the electrical load 230 as described above is consumed while the engine 240 is stopped, and thus the power generation module 210 does not supply charging power to the battery module 110, and there is a risk of completely discharging the battery module 110. In particular, when a lithium ion battery is used in a vehicle in which a start-stop mode is applied, due to low capacity thereof, a battery may be completely discharged by a dark current while the engine 240 of the vehicle is stopped.

According to some embodiments of the present invention as described above, if an SOC of the battery module 110 is decreased to a discharging limit or below due to the dark current, the starter motor 220 is automatically driven to thereby charge the battery module 110.

Hereinafter, a typical function of the BMS 120 and a method in which the BMS 120 charges the battery module 110 by monitoring an SOC of the battery module 110 and transmitting a control signal to the above-described peripheral devices is described.

The BMS 120 is connected to the battery module 110, and controls charging and discharging operations of the battery module 110. In addition, the BMS 120 may perform functions such as overcharge protection function, over-discharge protection function, over-current protection function, over-voltage protection function, overheating protection function, and cell balancing. To this end, the BMS 120 may include a measuring unit that measures a voltage, a current, a temperature, a remaining amount of power, a lifespan, an SOC, or the like, from the battery module 110, and may generate a control signal based on a measurement result to control external devices such as the starter motor 220 and the power generation module 210.

The BMS 120 determines a limit of an SOC so that the starter motor 220 may drive itself. In existing start-stop vehicles, a user has to start up engine 240 himself or herself or only the starter motor 220 may drive the engine 240, or the starter motor 220 drives engine 240 only in an idle go state, and the engine drives the power generation module 210. However, according to embodiments of the present invention, the starter motor 220 may be automatically driven by a control signal of the BMS 120.

In a start-stop vehicle, when a lithium ion battery is used as the battery module 110, advantages such as high output characteristics for implementing the same charging capacity with less volume and shorter charging time than a lead storage battery are available but since the capacity of the battery module 110 is smaller than that of a lead storage battery, the battery module 110 may be discharged quickly.

As a result, a period in which a lithium ion battery is completely discharged may be shorter than in a lead storage battery due to the electrical load 230 which requires power supply of a battery. In particular, like a dark current that is generated by the electrical load 230 which requires power even when turning off the engine 240 of the vehicle, the lithium ion battery is highly likely to completely discharge due to a dark current that consumes power uniformly even in a section where the vehicle is not driven. A lithium ion battery may be completely discharged within two or three weeks while the engine 240 of the vehicle is not started.

According to embodiments of the present invention, in order to solve this problem, the BMS 120 may monitor an SOC of the battery module 110 and sense when the SOC is decreased to a discharging limit or below. The discharging limit is a reference value for charging the battery module 110 by automatically driving the power generation module 210; for example, the discharging value is a value indicating to start charging the battery module 110 when a voltage value has reached the discharging limit, by determining that there is a risk of completely discharging the battery module 110.

The BMS 120 may generate a control signal for driving the starter motor 220 when the SOC has reached the discharging limit. When the starter motor 220 is driven by the control signal, the power generation module 210 is driven by rotation of the engine 240, thereby supplying charging power to the battery module 110.

In addition, the BMS 120 may set a charging limit to determine a power section to be used by the battery module 110. That is, the BMS 120 receives charging power from the power generation module 210 to charge the battery module 110 as described above, and when the BMS 120 senses that the SOC has reached a charging limit, the BMS 120 may generate a control signal indicating to stop driving of the power generation module 210 to end the charging.

The charging limit and the discharging limit set by the BMS 120 may be an SOC or another parameter for determining an SOC. Thus, in order to determine an SOC, the BMS 120 may use an SOC determination method such as a voltage measuring method, a current integration method, a current integration, and a Calman filter application method. The methods of determining the SOC are not limited to the above examples.

Also, as other parameters for determining an SOC, a charging limit and a discharging limit may be voltages. That is, the BMS 120 may measure a voltage of the battery module 110 by using any one of the above-described measuring units, and may determine whether the battery module 110 has reached the charging limit or the discharging limit according to the measured voltage.

According to another embodiment of the present invention, a predetermined period after the engine 240 of the vehicle is stopped, the BMS 120 may automatically generate a control signal for driving the starter motor 220 to charge the battery module 110. Accordingly, when the battery module 110 has linear SOC characteristics, the BMS 120 may charge the battery module 110 for a standard time period after the engine 240 is stopped, without having to monitor the SOC.

For example, the battery module 110 has linear SOC characteristics when a material of a battery includes soft carbon. The BMS 120 may set a time when an SOC (of the battery module) reaches a discharging limit by using characteristics of the battery module 110 after the engine 240 is stopped, and may generate a control signal for starting charging of the battery module 110 automatically at the previously set time. Likewise, the BMS 120 may set a time when (the SOC) reaches a charging limit after starting the charging, and may generate a control signal for automatically ending the charging of the battery module 110 at the previously set time.

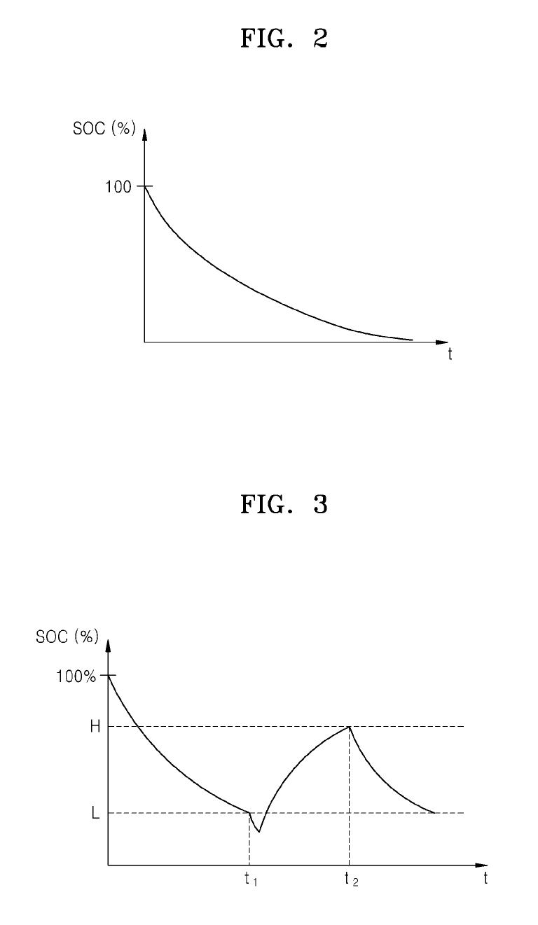

FIG. 2 is a graph showing an SOC of a battery module when engine 240 of a vehicle is stopped.

Referring to FIG. 2, the horizontal axis denotes time, and the vertical axis denotes SOC. Referring to FIG. 2, an SOC of the battery module 110 continuously decreases with time due to a dark current even when the engine 240 is stopped.

As described above, when a lithium ion battery is used in a start-stop vehicle, the lithium ion battery has lower capacity than a conventional lead storage battery, and thus, a graph of SOC in % may abruptly converge to 0. Accordingly, due to the complete discharging of the battery, the engine 240 may not be started up or restarted.

FIG. 3 is a graph showing an SOC of a battery module according to an embodiment of the present invention, when the battery module is automatically charged.

Also, referring to FIG. 3, a discharging limit of the battery module 110 is set as L. For example, a discharging limit L may be 30% when a completely charged SOC is 100%. In other embodiments, the limit L may be 70%, 60%, 40% or any other percentage of the completely charged SOC. The BMS 120 may monitor an SOC of the battery module 110, and when the SOC decreases to an L value or below, the starter motor 220 may be driven to thereby automatically drive the power generation module 210.

When the power generation module 210 is driven to supply charging power to the battery module 110, the BMS 120 generates a control signal for stopping driving of the power generation module 210 when an SOC is increased by a charging limit value H. Referring to FIG. 3, when the SOC corresponds to the discharging limit L, the power generation module 210 is driven to charge the battery module 110, and the driving of the power generation module 210 is stopped at a time t2 where the SOC of the battery module 110 reaches the charging limit H so as to detect discharging of the battery module 110 again.

For reference, the SOC is slightly decreased after a time t1 in FIG. 3 and then charging starts because the battery module 110 supplies driving power to the starter motor 220. Accordingly, a discharging limit L may be greater than power used to start up an engine 240 by the driving of the starter motor 220.

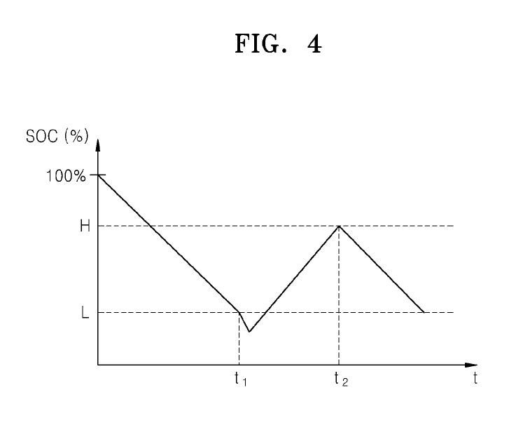

FIG. 4 is a graph showing an SOC of a battery module according to another embodiment of the present invention, when the battery module is automatically charged.

Referring to FIG. 4, an SOC of the battery module 110 according to another embodiment of the present invention has linear characteristics. Likewise, when the SOC graph has linear characteristics, even when the BMS 120 does not monitor the SOC of the battery module 110, it may be determined based on a previously provided reference value whether charging of the battery module 110 is necessary when a predetermined period of time passes.

For example, when it is known that the SOC has reached a discharging limit L at the time t1 due to a dark current based on the battery module 110 having linear SOC characteristics, the BMS 120 does not have to monitor an SOC but may drive the starter motor 220 at the time t1 after the engine 240 of the vehicle is stopped so that the power generation module 210 may charge the battery module 110.

Likewise, when the power generation module 210 charges the battery module 110, when it is known that an SOC has reached the charging limit H at a time t2 due to the battery characteristics, the BMS 120 may stop driving of the power generation module 210 at the time t2 without having to monitor an SOC, thereby stopping charging of the battery module 110.

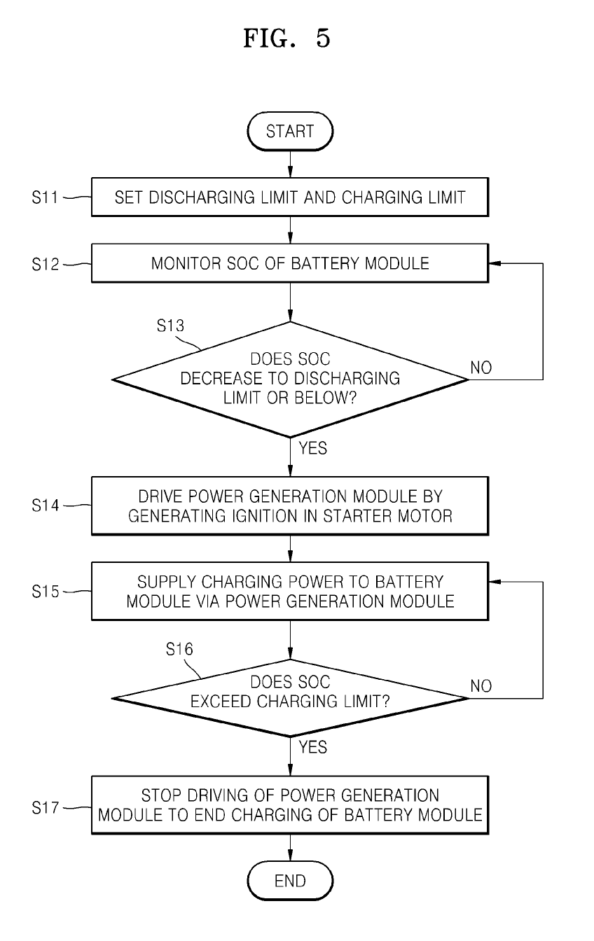

FIG. 5 is a flowchart illustrating a method of controlling a battery charging system, according to an embodiment of the present invention.

Referring to FIG. 5, first, a discharging limit of the BMS 120 is set when manufacturing a battery pack or by a user, in operation S11.

Next, the BMS 120 monitors an SOC of the battery module 110 that is discharged by a dark current after an engine of the vehicle is stopped, in operation S12.

Next, the BMS 120 senses whether an SOC of the battery module 110 is decreased to a discharging limit L or below in operation S13. If the SOC of the battery module 110 does not decrease to a discharging limit L, the BMS 20 continuously monitors an SOC of the battery module 110.

Otherwise, if the SOC is decreased to a discharging limit L or below, the BMS 120 generates a control signal indicating to drive the starter motor 220 so as to drive the power generation module 210 in operation S14.

Next, in operation S15, the power generation module 210 supplies charging power to the battery module 110.

Also, while charging continues, the BMS 120 senses whether the SOC of the battery module 110 exceeds a charging limit H in operation S16. If the BMS 120 does not exceed the charging limit H, the BMS 120 further monitors the SOC of the battery module 110.

Otherwise, if the SOC exceeds the charging limit H, the BMS 120 transmits a signal to the power generation module 210 to stop the driving thereof, thereby ending the charging of the battery module 110, in operation S17.

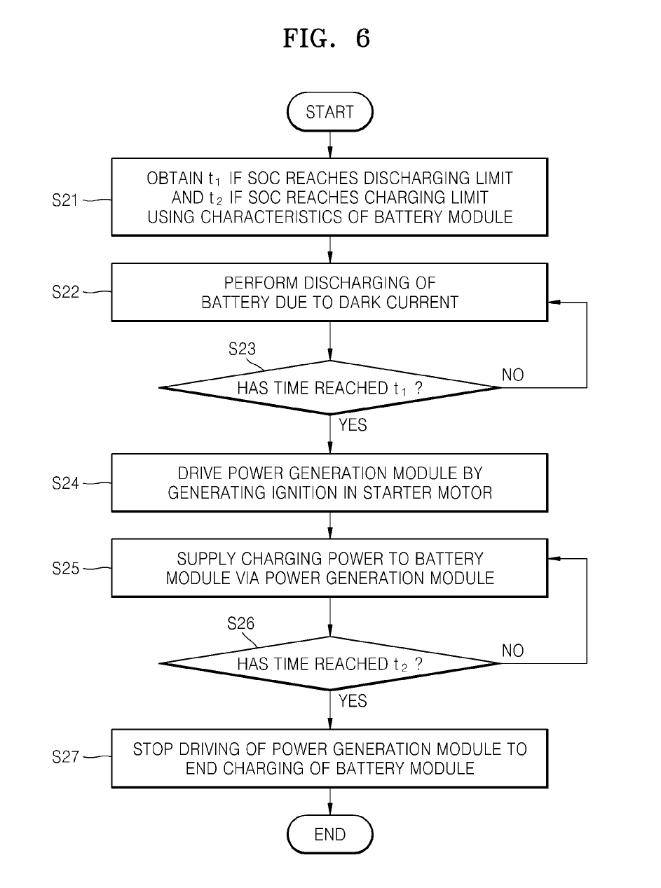

FIG. 6 is a flowchart illustrating a method of controlling a battery charging system, according to another embodiment of the present invention.

Referring to FIG. 6, first, in operation S21, a time t1 where an SOC becomes a discharging limit and a time t2 where an SOC becomes a charging limit are obtained by using characteristics of a battery module. Here, referring to FIG. 6, the battery module has linear SOC characteristics.

Next, discharging of a battery module is performed by a dark current, and an SOC of the battery module decreases linearly in operation S22.

Next, in operation S23, the BMS 120 senses whether the time t1 has been reached after the engine 240 is stopped. If the time t1 has not been reached, discharging of the battery module is further performed.

Otherwise, if the time t1 has been reached, the BMS 120 generates a control signal indicating to drive the starter motor 220, thereby driving the power generation module 210 in operation S24.

Next, in operation S25, the power generation module 210 supplies charging power to the battery module 110.

Next, in operation S26, the BMS 120 senses whether the time t2 has been reached. If the time t2 has not been reached, charging of the battery module 110 is further performed.

In operation S27, if the time t2 has been reached, the BMS 120 transmits a signal to the power generation module 210 to stop the driving thereof, thereby ending the charging of the battery module 110.

While this invention has been particularly shown and described with reference to certain embodiments thereof, it will be understood by those of ordinary skill in the art that various changes in form and details may be made therein without departing from the spirit and scope of the invention as defined by the appended claims. The described embodiments should be considered in descriptive sense only and not for purposes of limitation. Descriptions of features or aspects within each embodiment should typically be considered as available for other similar features or aspects in other embodiments. Therefore, the scope of the invention is defined not by the detailed description of the invention but by the appended claims, and all differences within the scope will be construed as being included in the present invention.

### EXPLANATION OF REFERENCE NUMERALS

100: battery pack

110: battery module

120: BMS

210: power generation module

220: starter motor

230: electrical load

240: engine

What is claimed is:

1. A method of charging a battery pack comprising:
determining a need for charging the battery pack;
sending a signal to a motor based on a determined need to charge the battery pack; and
initiating charging of the battery pack after receipt of the signal.

2. The method of claim 1, wherein determining the need for charging the battery is based on monitoring a state of charge (SOC) of the battery pack.

3. The method of claim 2, wherein determining the need for charging the battery pack is based on the SOC being below a threshold

4. The method of claim 1, wherein determining the need for charging the battery pack is based on passage of a predetermined time period.

5. The method of claim 4, wherein the predetermined time period is based on discharge characteristics of the battery pack.

6. The method of claim 1, wherein the motor is connected to a generator.

7. The method of claim 6, wherein the generator is operated to charge the battery pack when the signal is sent to the motor.

8. The method of claim 1, wherein the signal is indicative of the determined need for charging the battery pack.

9. The method of claim 1 wherein: determining a need for charging the battery pack comprises determining whether the battery pack is connected to an engine that is turned off; and wherein the signal is sent to the motor if the battery pack is connected to an engine that is turned off.

10. A method of charging a battery pack comprising:
monitoring a state of charge of a battery pack;
determining a need for charging the battery pack based on the monitored state of charge of the battery pack; and
triggering charging of the battery pack by sending a signal indicative of the need for charging the battery pack based on the determined need for charging the battery pack.

11. The method of claim 10, wherein determining the need for charging the battery pack comprises determining the need when the monitored state of charge of the battery pack crosses a predetermined threshold value.

12. The method of claim 11, wherein the predetermined threshold value comprises a percentage of a level associated with a completely charged battery pack.

13. The method of claim 10, wherein the triggering charging of the battery pack is further based on a predetermined time period.

14. The method of claim 13, wherein the predetermined time period is based on a linear discharge characteristic of the battery pack.

15. A battery pack comprising:
a controller configured to monitor a state of charge of a battery;
a processor configured to determine a need for charging the battery based on the state of charge of the battery; and
circuitry configured to trigger charging of the battery based on the determined need for charging the battery, wherein the circuitry is further configured to send a signal indicative of the need for charging the battery to a starter motor.

16. The battery pack of claim 15, wherein the battery pack is at least one of a lithium ion battery pack and a nickel metal hydride battery pack.

17. The battery pack of claim 15, wherein the signal sent to the starter motor is configured to automatically drive the power generator to charge the battery.

18. A vehicle comprising:
a battery pack comprising:
a controller configured to monitor a state of charge of a battery pack,
a processor configured to determine a need for charging the battery pack based on the state of charge of the battery pack, and
circuitry configured to trigger charging of the battery pack based on the determined need for charging the battery pack, wherein the circuitry is further configured to send a first signal indicative of the need for charging the battery pack to a starter motor;
the starter motor electrically connected to the battery pack, the starter motor configured to receive the first signal indicative of the need for charging the battery pack; and
a generator connected to the battery pack, the generator configured to charge the battery pack.

19. The vehicle of claim 18, wherein the circuitry is configured to send the first signal when the monitored state of charge of the battery pack is below a predetermined threshold value.

20. The vehicle of claim 18, wherein the circuitry is configured to send a second signal to the starter motor when the monitored state of charge of the battery pack is above a predetermined threshold value.
